(19) United States
(12) Patent Application Publication
(10) Pub. No.: US 2007/0124800 A1
(43) Pub. Date: May 31, 2007

(54) Image forming system, image forming program, management program and client apparatus

(75) Inventor: Masatoshi Kadota, Takahama-shi (JP)

Correspondence Address: OLIFF & BERRIDGE, PLC, P.O. BOX 19928, ALEXANDRIA, VA, 22320, US

(73) Assignee: BROTHER KOGYO KABUSHIKI KAISHA, NAGOYA-SHI (JP)

(21) Appl. No.: 11/604,245

(22) Filed: Nov. 27, 2006

(30) Foreign Application Priority Data
Nov. 29, 2005 (JP) 2005-344316

(51) Int. Cl. H04L 9/32; H04L 9/00; G06K 9/00; H04K 1/00; G06F 17/30; G06F 7/04

(52) U.S. Cl. 726/2; 713/182

(57) ABSTRACT

An image forming system includes: a server apparatus; a client apparatus connected via a network to the server apparatus; and an image forming apparatus connected to the client apparatus, wherein: the server apparatus includes: an authentication validation unit that makes authentication validation based on authentication information transmitted from the client apparatus; and a validation result information transmitting unit that transmits validation result information of the authentication validation unit to the client apparatus; and the client apparatus includes: an authentication information transmitting and receiving unit that transmits the authentication information to the server apparatus before transmitting print data for which a print request is made to the image forming apparatus, and receives the validation result information; and a print data transmission permitting unit that permits an operation of transmitting the print data to the image forming apparatus when the validation result information from the server apparatus indicates authentication success.

### CROSS-REFERENCE TO THE RELATED APPLICATION(S)

This application is based upon and claims priority from prior Japanese Patent Application No. 2005-344316 filed on Nov. 29, 2005, the entire content of which is incorporated herein by reference.

### TECHNICAL FIELD

Aspects of the present invention relate to an image forming system, an image forming program, a management program and a client apparatus.

### BACKGROUND

In JP-A-2003-330677, a technique has been disclosed in which the print data from the client side is all printed via a server to acquire a print log, and the acquired print log and the print data are accumulated and stored, thereby allowing the print data to be traced when a leakage of information occurs. Specifically, a server apparatus is connected via a network to the client apparatus and a printing apparatus. The print data generated in the client apparatus is transmitted to the server apparatus, which accumulates the print data and the print history information, including the information of the client apparatus in a storage device. The server apparatus transfers the print data to the printing apparatus, which produces printed output. In this case, the printing apparatus accumulates the printed results as print log in the storage device, and adds the accumulated print log to the storage device. The server apparatus analyzes the print log accumulated and stored in the storage device, and using a monitor program, a source of leakage is specified when a leakage of information occurs.

### SUMMARY

The technique as disclosed in JP-A-2003-330677 has a problem in that the processing load of the server apparatus is large, because all the print data is transferred via the server to the printing apparatus.

Aspects of the invention provide an image forming system that can manage the information printed out by the image forming apparatus while suppressing the processing load of a server apparatus.

According to an aspect of the invention, there is provided an image forming system including: a server apparatus; a client apparatus connected via a network to the server apparatus; and an image forming apparatus connected to the client apparatus, wherein: the server apparatus includes: an authentication validation unit that makes authentication validation based on authentication information transmitted from the client apparatus; and a validation result information transmitting unit that transmits validation result information of the authentication validation unit to the client apparatus; and the client apparatus includes: an authentication information transmitting and receiving unit that transmits the authentication information to the server apparatus before transmitting print data for which a print request is made to the image forming apparatus, and receives the validation result information from the server apparatus; and a print data transmission permitting unit that permits an operation of transmitting the print data to the image forming apparatus when the validation result information from the server apparatus indicates authentication success.

According to another aspect of the invention, there is provided an image forming program product including: software instruction which, when executed on a computer provided for a client apparatus connectable to a server apparatus and an image forming apparatus, enables the computer to perform predetermined operations; and a computer readable medium which stores the software instructions; the predetermined operations including: transmitting authentication information to the server apparatus before transmitting print data for which a print request is made to the image forming apparatus; receiving validation result information about an authentication in the server apparatus; and permitting an operation of transmitting the print data to the image forming apparatus when the validation result information indicates authentication success.

According to another aspect of the invention, there is provided a management program product including: software instruction which, when executed on a computer provided for a server apparatus connectable to a client apparatus connected to an image forming apparatus, enables the computer to perform predetermined operations; and a computer readable medium which stores the software instructions; the predetermined operations including: making authentication validation based on authentication information transmitted from the client apparatus; and transmitting validation result information to the client apparatus.

According to another aspect of the invention, there is provided a client apparatus connectable to a server apparatus and an image forming apparatus, the client apparatus. including: an authentication.information transmitting and receiving unit that transmits authentication information to the server apparatus before transmitting print data for which a print request is made to the image forming apparatus, and receives validation result information about an authentication in the server apparatus; and a print data transmission permitting unit that permits an operation of transmitting the print data to the image forming apparatus when the validation result information from the server apparatus indicates authentication success.

### BRIEF DESCRIPTION OF THE DRAWINGS

FIG. 1 is a block diagram showing an image forming system according to an aspect of the present invention;

FIG. 2 is a block diagram showing the configuration of a client apparatus;

FIG. 3 is a functional block diagram showing the functions for the printing process in the client apparatus;

FIG. 4 is a flowchart showing a “StartDocPort” process performed by a language monitor;

FIG. 5 is a flowchart showing the processing contents of a monitor thread on the client apparatus side;

FIG. 6 is a flowchart showing the processing contents performed by a main body unit on the server apparatus side;

FIG. 7 is a flowchart showing the processing contents of the monitor thread on the server apparatus side;

FIG. 8 is a data organization view of a reference database; and

FIG. 9 is a data organization view of a log information database.

### DETAILED DESCRIPTION

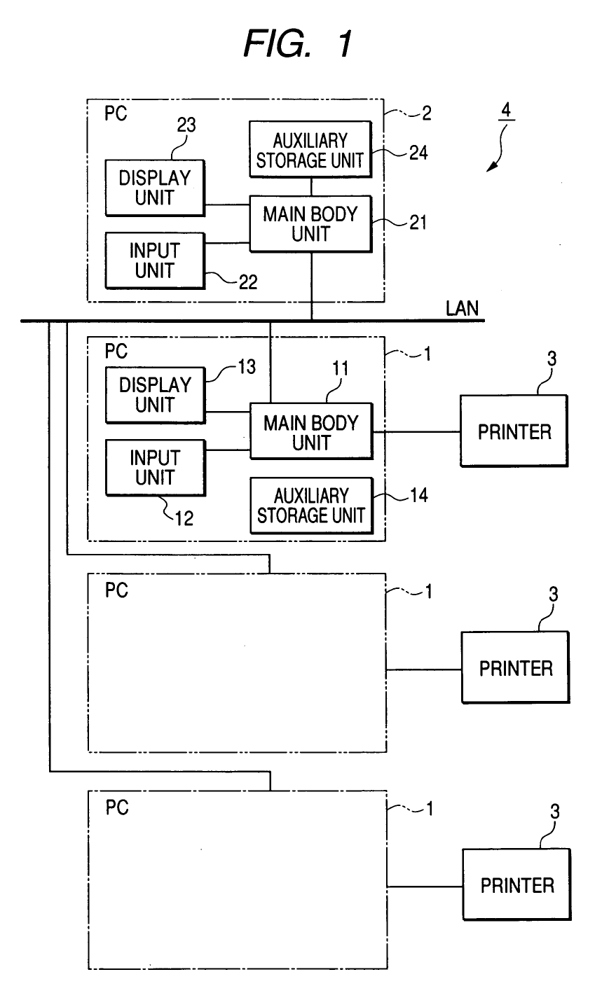

Referring to FIGS. 1 to 9, an aspect of the present invention will be described below.

FIG. 1 is a block diagram showing an image forming system 4 in which a plurality of client apparatuses 1 (managed PCs) and a server apparatus 2 are interconnected via a local area network (LAN). Also, each client apparatus 1 is locally connected to a printer 3 (e.g. an “image forming apparatus” of the invention). This image forming system 4 collectively manages whether or not the print data requested to print from each client apparatus 1 is permitted to produce printed output on the printer 3 and log information regarding its print data in the server apparatus 2.

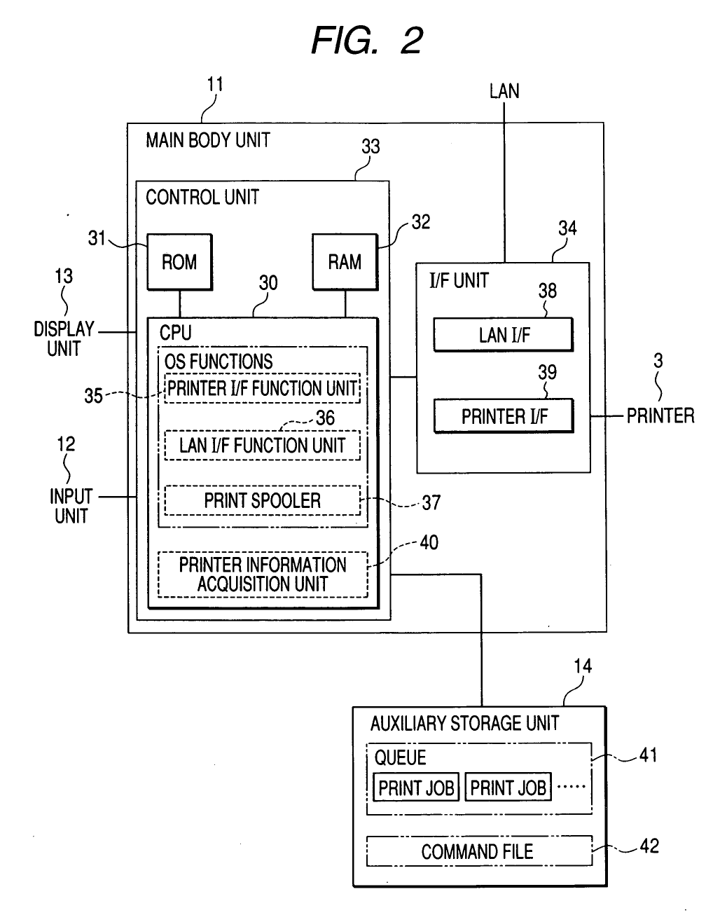

Each client apparatus 1 comprises a main body unit 11 having a control unit 33 mainly composed of a CPU 30, a ROM 31 and a RAM 32 and an I/F unit 34 for connecting the control unit 33 and various kinds of device, an input unit 12 such as a keyboard and a pointing device, a display unit 13 such as a display and an auxiliary storage unit 14 such as a hard disk, as shown in FIG. 2.

The main body unit 11 mounts a Windows (R) as the operating system (OS), in which the functions commonly used from the application, such as a printer I/F function unit 35, a LAN I/F function unit 36 and a print spooler 37 are implemented by a software module packaged as a part of the OS. An input/output function for the keyboard input and the screen output and a function of managing the hard disk or memory are also provided by the OS. If the equivalent functions are implemented, the client apparatus 1 may mount any other OS (e.g., Linus (R), MacOS (R) etc.). The following explanation is continued on the premise that the client apparatus 1 has various functions provided by the Windows (R) OS.

The I/F unit 34 of the main body unit 11 is provided with a LAN I/F 38 such as a LAN card and a printer I/F 39 such as a universal serial bus (USB) port or a parallel board, in addition to the I/F with the input unit 12, the display unit 13 and the auxiliary storage unit 14. The client apparatus is connected to the LAN via a LAN cable connected to the LAN I/F 38, and the client apparatus 1 and the printer 3 are locally connected via a printer cable connected to the printer I/F 39.

This client apparatus 1 installs software for fulfilling a function of acquiring the printer information from the printer 3 connected to the client apparatus 1 and providing the printer information to the server apparatus 2, and functions as a printer information acquisition unit 40 when this software runs on the CPU 30.

The server apparatus 2 is similar to the client apparatus 1, and comprises a main body unit 21, an input unit 22, a display unit 23, and an auxiliary storage unit 24. The main body unit 21 mounts a Windows (R) as the OS. If the equivalent functions are implemented, the server apparatus 2 may mount any other OS (e.g., Linus (R), MacOS (R) etc.). The following explanation is continued on the premise that the server apparatus 2 has various functions provided by the Windows (R) OS.

The printer 3 is the managed printer to be managed by the server apparatus 2. The printer 3 supports a printer job language (PJL). A command described in the PJL is read from a command file 42, and given from the client apparatus 1 to the printer 3, so that the information corresponding to the command is returned from the printer 3 to the client apparatus 1. The PJL is a command language capable of controlling various kinds of functions provided for the image forming apparatus.

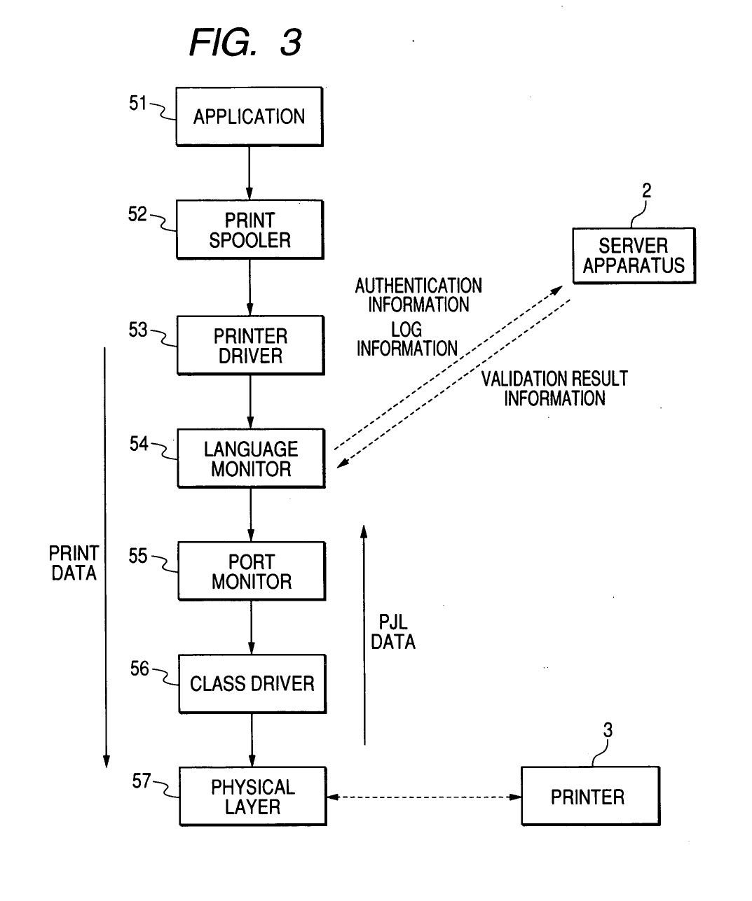

FIG. 3 is a functional block diagram showing the functions for the printing process performed by Windows (R) mounted on the client apparatus 1. As shown in FIG. 3, the client apparatus 1 has a print spooler 52, a language monitor 54 and aport monitor 55, as a program module for transferring the print data to the printer 3. The print data (e.g., intermediate file such as metafile) from an application 51 for producing printed output using the print spooler 52 is passed to the print spooler 52. In the print spooler 52, the received print data is stored as a print job in a print job queue 41. The print job queue 41 is managed to process the print jobs in the storing order.

The print data from the print spooler 52 is converted into print description language (PDL) data by the printer driver 53, and delivered to the language monitor 54. Herein, the language monitor 54 is a print manager that receives the print status data from the printer 3 having a capability of bi-directional communication. Specifically, the language monitor 54 essentially provides a bi-directional communication path between the printer 3 supporting the bi-directional communication and the print spooler 52. The PJL command as the predefined printer control command can be appended to a data stream. The printer 3 analyzes the PJL command appended to the data stream, and performs the operation corresponding to the PJL command. When the printer 3 returns a return value according to the PJL command (e.g., indicating whether the print job is normally ended or an error occurs), the language monitor can receive the return value as PJL data from the printer 3.

The PDL data and the PJL command from the language monitor 54 are passed through the port monitor 55 and a class driver 56 to a physical layer 57, and finally sent to the printer 3.

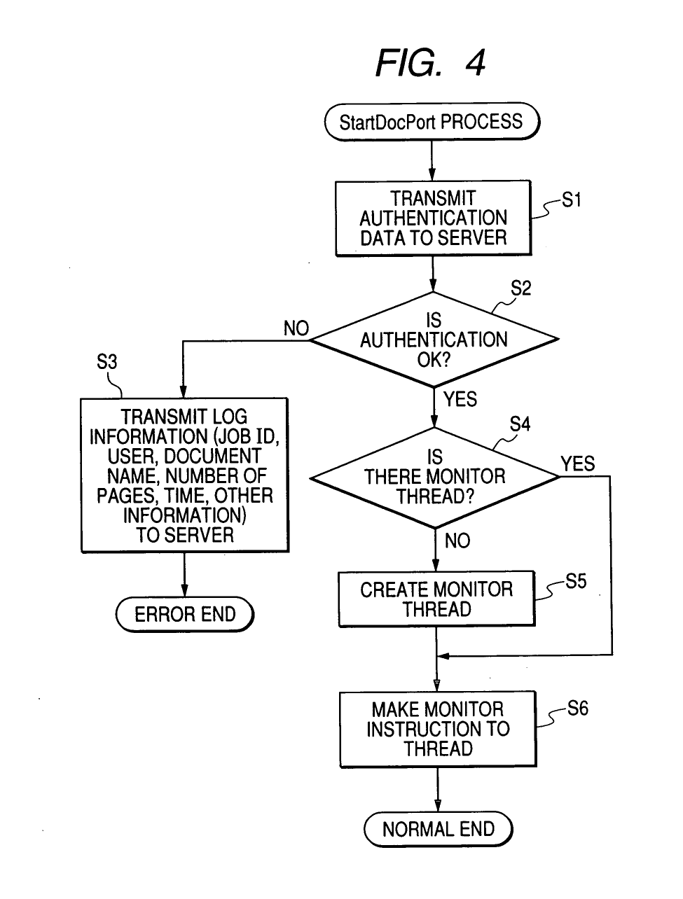

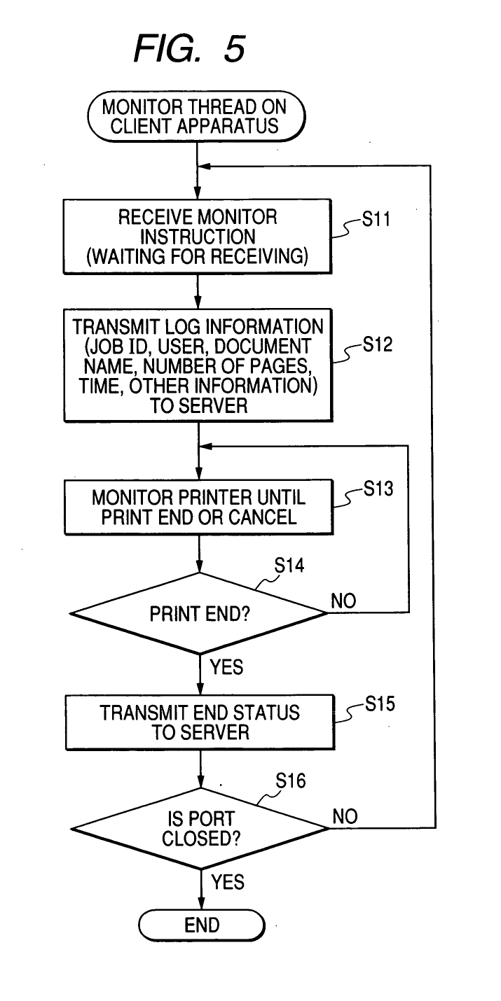

FIGS. 4 and 5 are flowcharts showing the processing contents performed mainly by the language monitor 54. A process of the language monitor 54 is started by calling a “StartDocPort” as one application program interface (API) when a print request is issued from the application 51, and the print spooler 52 outputs the print data via the language monitor 54. The language monitor 54 basically performs a process (see FIG. 4) according to the “StartDocPort” called from the print spooler 52 and then performs a process according to a “WritePort”. If the print data passed from the print spooler 52 is not finished, the process according to the “WritePort” is repeated again. However, if the print data passed from the print spooler 52 is finished, the process according to an “EndDocPort” is performed, whereby this procedure is ended.

FIG. 4 is a flowchart showing the “StartDocPort” process performed by the language monitor 54. The language monitor 54 analyzes the header information of the print data from the print spooler 52 at S1, and acquires the authentication information of the print data such as a “user name (print requester name)” (equivalent to the “creator of print data” of the invention) and a “document name” (equivalent to the “application name” of the invention), as well as “print job ID”, “user name”, “document name”, “number of pages in the document”, “print request time”, and “name of the client apparatus 1 which sends the print request” as the log information. The log information is stored in a log information database in the server apparatus 2. The language monitor 54 transmits the above authentication information (authentication data) to the server apparatus 22. In this aspect, the “user name” is employed, but a password, for example, may be employed as far as it is usable as the user identification information.

The authentication information transmitted from the client apparatus 1 is authenticated and validated based on the reference information in the server apparatus 2, as will be described later, and its validation result information (authentication success or authentication failure) is returned to the client apparatus 1. At this time, the language monitor 54 functions as “an authentication information transmitting/receiving unit” of the invention. If the validation result information returned from the server apparatus 2 has content indicating authentication failure (“N” at S2), the language monitor 54 transmits the log information to the server apparatus 2 at S3, in which the print data is discarded, the operation is abnormally ended, and the transmission to the printer 3 is disabled. For example, in this image forming system 4, the print data in which authentication fails can not be printed out on the printer 3 may be because the print request for such is issued by a user who is not authorized for the printing process, or the document is essentially not permitted for the printing process.

On the other hand, if the validation result information returned from the server apparatus 2 has content indicating authentication success (“Y” at S2), the language monitor 54. transfers to step S4. In this aspect, for example, when the server apparatus 2 is not started, and the validation result information is not returned from the server apparatus 2 within a predetermined period of time after the authentication information is transmitted, the task is abnormally ended, whereby the print data is not transmitted to the printer 3.

The language monitor 54 checks whether or not any object of monitor thread has been created at S4. If no object of monitor thread has been created (“N” at S4), the monitor thread is created (S5). After the creation of the monitor thread, a monitor instruction is send to the monitor thread at S6, and the operation is normally ended.

If an object of monitor thread has been created (“Y” at S4), a monitor instruction is send to the monitor thread at S6, and the operation is normally ended. Thereafter, the language monitor 54 transfers to a “WritePort” process to transmit the print data to the printer 3 which is permitted to perform the printing process. Accordingly, the language monitor 54 may. function as “a print data transmission permitting unit” of the invention.

FIG. 5 is a flowchart showing the processing contents of the monitor thread in which the object is created and executed at S5 of FIG. 4. The language monitor 54 performs the “StartDocPort” process of FIG. 4 and the monitor thread in parallel in a multi-task. The monitor thread mainly monitors the processing state in the printer 3 for the transmitted print data. And the monitor thread monitors the exchanging of the PJL command and the return value from the printer 3 (as PJL data) between the language monitor 54 and the printer 3, as previously described.

The monitor thread is kept waiting until the “StartDocPort” process sends a monitor instruction to the monitor thread. The monitor instruction makes the monitor thread start monitoring. If a monitor instruction is send to the monitor thread(S11), the log information is transmitted to the server apparatus 2 at S12. In this aspect, the language monitor 54 stores successive monitor instructions issued in order for each print job through the “StartDocPort” process in a monitor queue (equivalent to a “queue” of the invention), and performs the monitoring operation in the storing order. At this time, the language monitor 54 may function as “a monitoring unit” of the invention.

The processing state of the printer 3 for the print data corresponding to the monitor instruction being currently executed is monitored at S13 and S14. Herein, the language monitor 54 acquires the status data as to whether the printing process on the printer 3 is normally ended or abnormally ended because of the status that means “printing is impossible” (e.g. status means “paper is running out”, “toner is running out” or the like) from the printer 3.

Also, when a cancel process for the print data being currently executed is performed on the side of the client apparatus 1, the language monitor also receives a cancel termination notice from the “EndDocPort” process and acquires it as termination information. Thereafter, the language monitor 54 transmits the termination information as the termination status data to the server apparatus 2 at S15. This monitor thread is operative in a monitor operable state, for example, until the Windows (R) OS is ended and a “ClosePort” process is ended (S16).

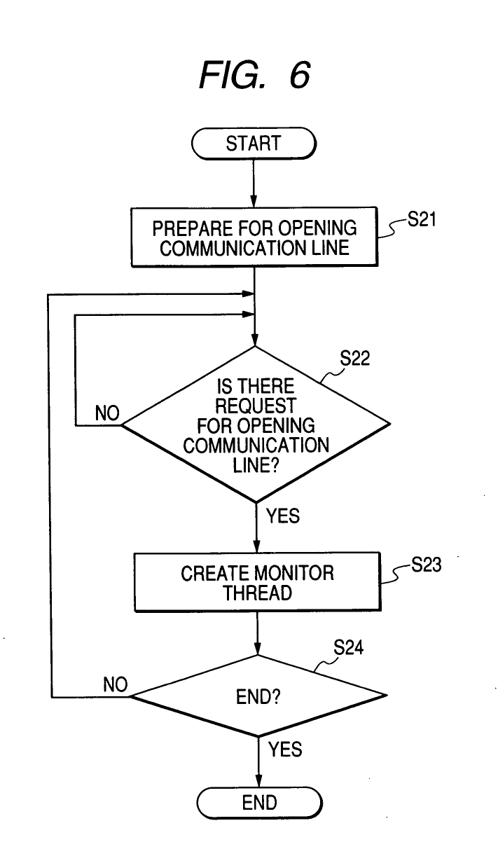

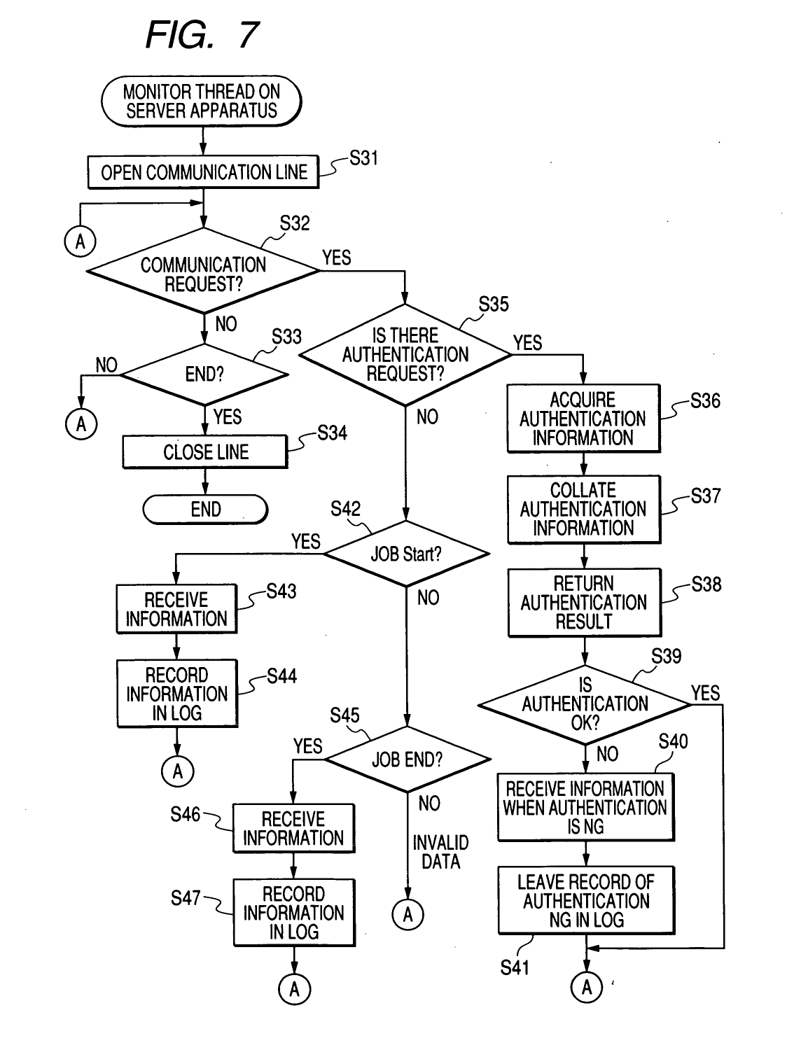

FIGS. 6 and 7 are flowcharts showing the processing contents performed by the main body unit 21 of the server apparatus 2. When the processing contents performed by a main body unit on the server apparatus 2 start, the main body unit 21 makes the communication line connectable with the server apparatus 2 at S21 in FIG. 6, and the server apparatus 2 is kept waiting until any one of the client apparatuses 1 sends a request for opening the communication line to the server apparatus 2 (S22). If a request from one of the client apparatuses 1 is received, an object of the monitor thread for the client apparatus 1 is created and the printer 3 locally connected thereto (S23, S24).

One monitor thread is created for each one of a plurality of client apparatuses 1 to be monitored by the server apparatus 2. The server aparatus 2 executes a plurality of monitor threads in parallel through the multi-task process. The monitor threads are exactly the same process, a flowchart of which is shown in FIG. 7. If the communication line with the client apparatus 1 corresponding to the monitor thread is opened at S31, the monitor thread is placed in an idle state to wait for a communication request from the client apparatus 1. If there is no communication request in the idle state and the task is ended, the communication line with the client apparatus 1 is closed and the procedure is ended (“Y” at S33, S34).

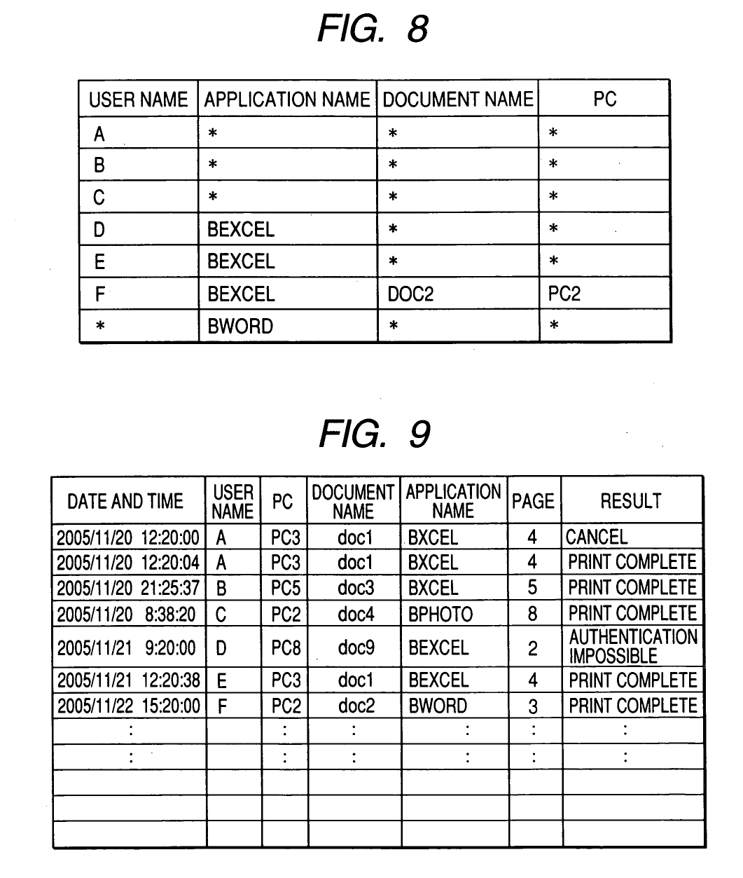

On the other hand, if any one of the client apparatuses 1 sends a communication request and an authentication request to the server apparatus 2 while the server apparatus 2 is in the idle state (“Y” at S32, S35), the authentication information is acquired from the client apparatus 1 at S36, and the authentication validation is made by collating the authentication information and the reference information at S37. Herein, the server apparatus 2 stores a reference database as shown in FIG. 8 in the auxiliary storage unit 24. In this reference database, the application name, the document name and the client apparatus name, for which the printing process is permitted, are stored as the reference information for each user. In FIG. 8, the asterisk “*” means no limitation. For example, the users A, B and C are permitted to perform the printing process without limitation. The users D and E are permitted only if the printing is performed with a specific application (BEXCEL). The user F is permitted only in the case of printing the specific document having the name “DOC2” with the specific application (BEXCEL) from the specific client apparatus 1 having the name “PC2” among the plurality of client apparatuses 1.

In this aspect, the user name and the application name are only transmitted as the authentication information from each client apparatus 1, whereby the authentication validation is made by collation about only two items of the user name and the application name. The server apparatus 2 returns the validation result information to the client apparatus 1 at S38. If the validation result is authentication failure (“N” at S39), the server apparatus receives the log information transmitted from the client apparatus 1 at S3 of FIG. 4 and stores it associated with the information indicating authentication failure in the auxiliary storage unit 24 (S40, S41).

If a communication request other than the authentication request is received at S35 (“N” at S35) and the communication request indicates the print job start (“Y” at S42), the main body unit 21 receives the log information transmitted from the client apparatus 1 at S12 of FIG. 5 and stores it in the auxiliary storage unit 24 (S43, S44), whereby the procedure returns to S32. If the communication request indicates the print job end (“N” at S42, “Y” at S45), the main body unit receives the end status data transmitted from the client apparatus 1 at S15 of FIG. 5, and stores it associated with the log information corresponding to the same print job received at S43 in the auxiliary storage unit 24 (S46, S47), whereby the procedure returns to S32. In the above process, the main body unit 21 may function as “an authentication validation unit” and “a validation result information transmitting unit” of the invention.

In the above process, the server apparatus 2 can store the log information for the print job performed in each client apparatus 1 (e.g. the print request time, the identification information of the client apparatus 1 making the print request, the document name, the application name, the number of pages, the authentication result print end information, or the like), associated with the print job ID, in the log information database in the auxiliary storage unit 24, as shown in FIG. 9.

With this aspect, the printing process in the printer 3 is permitted only if the authentication in the server apparatus 2 is successful, based on the authentication information of print data, for the print job requested to print in each client apparatus 1. Thereby, the processing load of the server apparatus can be lower than the conventional system where the print data from each client apparatus 1 is transmitted to the server apparatus 2 for management. Also, in this aspect, the print job for the printer 3 locally connected to each client apparatus 1 can be managed.

Also, since a print job with authentication failure in the server apparatus 2 is inhibited to produce any printed output in the printer 3, the leakage of classified information is suppressed. Since the log information regarding the print job with authentication failure is stored in the server apparatus 2, the print data for which a print request is attempted without permission can be traced based on this log information.

Also, since the log information regarding the print job with authentication success is also stored in the server apparatus 2, a follow-up survey for leakage of information that cannot be deterred by authentication validation can be performed based on this log information. Moreover, with regard to the print job with authentication success, the print end information is stored together with the log information in the printer 3, where by whether the printing is normally performed or abnormally ended can be recorded.

Also, the monitor thread executed in the client apparatus 1 is configured to manage the monitor instructions sent successively in the queue, and monitor the next print job after the printing process for the previous print job is ended on the printer 3, whereby a smooth monitoring process for plural print requests can be made.

Moreover, the language monitor 54 receives the printer status data from the printer 3 having the capability of bi-directional communication, and has essentially the function of monitoring the processing state in the printer 3. Accordingly, the invention may be embodied using the language monitor 24 in this aspect.

Also, in this aspect, the authentication validation for a plurality of client apparatuses 1 is performed on the single server apparatus 2, and further, the log information of the plurality of client apparatuses 1 is collectively stored in the single server apparatus 2. Usually, in the case where such configuration is taken in the conventional system, the print data of the plurality of client apparatuses 1 flows into the single server apparatus 2, giving rise to a very large processing load.

However, in this aspect, even if a large number of client apparatuses 1 make frequent print requests, the server apparatus simply processes the authentication validation and stores the log information, whereby the processing load on the server apparatus 2 is relieved.

From the point of view of information security in recent years, the output from the host computer (client apparatus 1) to the printer 3 has been made via a local connection interface but not via the network as in this aspect of the present invention. In this case, when the function of making the log is necessary as with the conventional system, it is required to make the log management for each host computer. Therefore, the administrator is required to have an enormous load to sum up the log information. In this aspect of the present invention, there is an advantage that the log management of the printer 3 locally connected can be collectively made in the server apparatus 2, whereby the load on the administrator is significantly reduced.

The present invention is not limited to the above aspect as described above and shown in the drawings, but the following aspects, for example, maybe also included in the technical scope of the invention.

While in the above aspect, the log information of print data is transmitted to the server apparatus 2 after the validation result information is received, however, the log information may be transmitted together with the authentication information.

While in the above aspect, the authentication information is transmitted to the server apparatus 2 to make authentication validation at the time of making the print request, however, the authentication information may be transmitted when the client apparatus 1 is connected via the network to the server apparatus 2 at start-up, or when the client apparatus is connected to the server apparatus 2 by entering a personal password, whereby the authentication validation is made based on this authentication information.

While in the above aspect, the authentication validation in the server apparatus 2 is performed for two items of the user name and the application name, however, any one item of the user name and the application name may be employed. Also, the “document name (document title)” and the “identification information of the client apparatus” for the print data may be transmitted as the authentication information from the client apparatus 1 to the server apparatus 2, thereby making the authentication validation only for these items, or including these items.

The printer 3 may be the local printer locally connected to the client apparatus 1, or may be connected via the network to the client apparatus 1 and the server apparatus 2.

What is claimed is:

1. An image forming system comprising:
a server apparatus;
a client apparatus connected via a network to the server apparatus; and
an image forming apparatus connected to the client apparatus, wherein:
the server apparatus comprises:
an authentication validation unit that makes authentication validation based on authentication information transmitted from the client apparatus; and
a validation result information transmitting unit that transmits validation result information of the authentication validation unit to the client apparatus;
and the client apparatus comprises:
an authentication information transmitting and receiving unit that transmits the authentication information to the server apparatus before transmitting print data for which a print request is made to the image forming apparatus, and receives the validation result information from the server apparatus; and
a print data transmission permitting unit that permits an operation of transmitting the print data to the image forming apparatus when the validation result information from the server apparatus indicates authentication success.

2. The image forming system according to claim 1, wherein:
the authentication information comprises reference information regarding at least one of a creator of the print data and an application name of generating the print data;
the server apparatus further comprises a reference information storage unit that stores the reference information regarding at least one of the creator of the print data and the application name to permit print output; and
the authentication validation unit makes the authentication validation based on the authentication information and the reference information.

3. The image forming system according to claim 1, wherein:
the client apparatus further comprises a log information transmitting unit that transmits log information regarding the print data to the server apparatus before the print data is transmitted to the image forming apparatus; and
the server apparatus further comprises a management storage unit that stores the log information transmitted from the client apparatus if the validation result information of the authentication validation unit indicates authentication failure.

4. The image forming system according to claim 1, wherein:
the client apparatus further comprises a log information transmitting unit that transmits log information regarding the print data to the server apparatus before the print data is transmitted to the image forming apparatus; and
the server apparatus further comprises a management storage unit that stores the log information transmitted from the client apparatus if the validation result information of the authentication validation unit indicates authentication success.

5. The image forming system according to claim 4, wherein:
the client apparatus further comprises a monitor unit that monitors a processing state of the image forming apparatus for the print data permitted and transmitted by the print data transmission permitting unit;
the log information transmitting unit transmits end information of a printing process to the server apparatus after the monitor unit confirms that the printing process for the print data is ended in the image forming apparatus; and
the server apparatus stores the end information associated with the log information in the management storage unit.

6. The image forming system according to claim 5, wherein:
the monitor unit includes a queue for temporarily storing monitor instruction information for the print data permitted and transmitted by the print data transmission permitting unit, and the monitor unit performs a monitor process for next print data successively after a monitor process for previous print data is ended.

7. The image forming system according to claim 5, wherein:
the client apparatus further comprises a language monitor that includes the authentication information transmitting and receiving unit and the monitor unit; and
the language monitor acquires the authentication information included in the print data for which a print request is made.

8. An image forming program product embodied on a computer-readable medium, which when executed on a computer provided for a client apparatus connectable to a server apparatus and an image forming apparatus, enables the computer to perform predetermined operations, the predetermined operations comprising:
transmitting authentication information to the server apparatus before transmitting print data for which a print request is made to the image forming apparatus;
receiving validation result information about an authentication in the server apparatus; and
permitting an operation of transmitting the print data to the image forming apparatus when the validation result information indicates authentication success.

9. A management program product embodied on a computer-readable medium, which when executed on a computer provided for a server apparatus connectable to a client apparatus connected to an image forming apparatus, enables the computer to perform predetermined operations, the predetermined operations comprising:
making authentication validation based on authentication information transmitted from the client apparatus; and
transmitting validation result information to the client apparatus.

10. A client apparatus connectable to a server apparatus and an image forming apparatus, the client apparatus comprising:
an authentication information transmitting and receiving unit that transmits authentication information to the server apparatus before transmitting print data for which a print request is made to the image forming apparatus, and receives validation result information about an authentication in the server apparatus; and
a print data transmission permitting unit that permits an operation of transmitting the print data to the image forming apparatus when the validation result information from the server apparatus indicates authentication success.

11. The client apparatus according to claim 10, further comprising:
a log information transmitting unit that transmits log information regarding the print data to the server apparatus before the print data is transmitted to the image forming apparatus.

12. The client apparatus according to claim 11, further comprising:
a monitor unit that monitors a processing state of the image forming apparatus for the print data permitted and transmitted by the print data transmission permitting unit, wherein
the log information transmitting unit transmits end information of a printing process to the server apparatus after the monitor unit confirms that the printing process for the print data is ended in the image forming apparatus.
